(19) United States
(12) Patent Application Publication
(10) Pub. No.: US 2025/0074689 A1
(43) Pub. Date: Mar. 6, 2025

(54) SAFETY COLLAR FOR A PRESSURIZED CONTAINER

(71) Applicant: Total Safety U.S., Inc., Pasadena, TX (US)

(72) Inventors: Jeremy Ethan JUTILA, Williston, ND (US); David Alan TEIXEIRA, La Porte, TX (US)

(73) Assignee: Total Safety U.S., Inc., Pasadena, TX (US)

(21) Appl. No.: 18/821,994

(22) Filed: Aug. 30, 2024

Related U.S. Application Data
(60) Provisional application No. 63/579,582, filed on Aug. 30, 2023.

(51) Int. Cl. B65D 83/40; B65D 50/06

(52) U.S. Cl. CPC B65D 83/40; B65D 50/062

(57) ABSTRACT

A safety collar, systems, and methods are provided. The safety collar includes an anchor for securing the safety collar to a pressurized container and a retention slot for retaining and anchoring one or more pressurized components to the anchor. The safety collar anchors the one or more pressurized components to the pressurized container when the one or more pressurized components are decoupled from the pressurized container without first depressurizing the pressurized container.

### CROSS REFERENCE TO RELATED APPLICATIONS

This application is a non-provisional application of, and thereby claims benefit under 35 U.S.C. § 119(e) to, U.S. Patent Application Ser. No. 63/579,582 filed on Aug. 30, 2023, and incorporated herein by reference in its entirety.

### BACKGROUND

Pressurized containers are used in a variety of applications. Pressurized containers may be part of a station that provide access to the contents of the pressurized container. For example, pressurized containers that are portable eyewash stations provide emergency eyewash solutions in locations where access to water is limited. The stations often include pressurized components such as spray heads, handles, hoses, relief valves, and other accessories for their proper functioning. An issue arises when the pressurized components are inadvertently decoupled from the pressurized container, leading to the sudden release of pressurized elements, and resulting in potential injuries to personnel.

### SUMMARY

Example aspects of the present disclosure include:

In general, in one aspect, one or more embodiment relate to a safety collar comprising an elongated body extending from a first end to a second end; a first member extending from the first end, the first member extending perpendicularly to the elongated body; a second member extending from the second end, the second member extending perpendicularly to the elongated body; a retention slot formed in the first member, the retention slot operable to receive a first portion of a pressurized container; and a collar clamp formed in the second member, the clamp operable to receive a second portion of the pressurized container, wherein the retention slot anchors the first portion to the second portion when the first portion is decoupled from the second portion while pressurized.

Any of the aspects herein, wherein the first portion of the pressurized container comprises one or more pressurized components and the second portion of the pressurized container comprises a solution reservoir.

Any of the aspects herein, further comprising: a first corner formed at the first member and the elongated body and a second corner formed at the second member and the elongated body.

Any of the aspects herein, wherein the first corner and the second corner are each rounded, radial corners.

Any of the aspects herein, wherein the safety collar has a thickness of at least ⅜″.

Any of the aspects herein, wherein the collar clamp comprises a first clamp member formed in the second member and a second clamp member that is releasably secured to the first clamp member.

Any of the aspects herein, wherein the collar clamp has a mounting hole defining a mounting hole profile.

Any of the aspects herein, wherein the mounting hole profile has an ovate shape.

Any of the aspects herein, wherein the retention slot is defined by a pair of arms.

Any of the aspects herein, wherein each arm of the pair of arms has at least one of a rounded or chamfered end.

In general, in one aspect, one or more embodiment relate to a system comprising a pressurized container having a solution reservoir and one or more pressurized components releasably attached to and extending from the solution reservoir; and a safety collar having a retention slot operable to receive at least a portion of the one or more pressurized components and an anchor operable to be anchored to the solution reservoir, wherein the retention slot anchors the one or more pressurized components to the solution reservoir when the pressurized container is decoupled from the solution reservoir while pressurized.

Any of the aspects herein, wherein the safety collar has a thickness of at least ⅜″.

Any of the aspects herein, wherein the anchor comprises: a first arm extending from the retention slot; and a second arm extending from the retention slot in an opposite direction of the first arm, wherein the first arm extends to a first clamp operable to be secured to the solution reservoir at a first location and the second arm extends to a second clamp operable to be secured to the solution reservoir at a second location.

Any of the aspects herein, wherein safety collar comprises: an elongated body extending from a first end to a second end; a first member extending from the first end, the first member extending perpendicularly to the elongated body; and a second member extending from the second end, the second member extending perpendicularly to the elongated body, wherein the retention slot is formed in the first member and the anchor is formed in the second member.

Any of the aspects herein, wherein the anchor is a collar clamp and the collar clamp comprises a first clamp member formed in the second member and a second clamp member that is releasably secured to the first clamp member.

Any of the aspects herein, wherein the collar clamp has a mounting hole defining a mounting hole profile.

Any of the aspects herein, wherein the mounting hole profile has an ovate shape.

In general, in one aspect, one or more embodiment relate to a method of decoupling one or more pressurized components from a solution reservoir of a pressurized container comprising decoupling the one or more pressurized components from the solution reservoir, the solution reservoir being pressurized; retaining the one or more pressurized components on the solution reservoir when the one or more pressurized components are decoupled from the solution reservoir by a safety collar, the safety collar having an anchor secured to the solution reservoir and a retention slot retaining the one or more pressurized components; and removing the safety collar from the pressurized container.

Any of the aspects herein, wherein safety collar comprises: an elongated body extending from a first end to a second end; a first member extending from the first end, the first member extending perpendicularly to the elongated body; and a second member extending from the second end, the second member extending perpendicularly to the elongated body, wherein the retention slot is formed in the first member and the anchor is formed in the second member.

Any of the aspects herein, wherein the anchor comprises: a first arm extending from the retention slot; and a second arm extending from the retention slot in an opposite direction of the first arm, wherein the first arm extends to a first clamp operable to be secured to the solution reservoir at a first location and the second arm extends to a second clamp operable to be secured to the solution reservoir at a second location.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF DRAWINGS

FIG. 1 shows a pressurized container, in accordance with one or more embodiments.

FIG. 2 is a safety collar attached to a pressurized container according to illustrative embodiments.

FIGS. 3A and 3B are additional views of a safety collar attached to a pressurized container according to illustrative embodiments.

FIG. 4 is a safety collar shown according to illustrative embodiments.

FIG. 5A shows a schematic drawing of a side view of a safety collar according to illustrative embodiments.

FIG. 5B shows a schematic drawing of a profile of a mounting hole of a collar clamp of the safety collar according to illustrative embodiments.

FIGS. 6A and 6B show a collar clamp of the safety collar having an ovate shaped mounting hole mounted to a first stem and a second stem, respectively, according to illustrative embodiments.

FIGS. 7A and 7B show a safety collar attached to a pressurized container according to illustrative embodiments.

FIG. 8 shows a method for coupling a safety collar to a pressurized container, in accordance with one or more embodiments.

FIG. 9 shows a method for decoupling one or more pressurized components from a pressurized container, in accordance with one or more embodiments.

### DETAILED DESCRIPTION

In general, embodiments are directed to a safety collar (also referred to herein as a “collar”) designed to secure pressurized components of a pressurized container. The safety collar is configured to engage with a stem and a solution reservoir of the pressurized container to prevent unintended decoupling of pressurized components, thereby reducing the risk of injury to personnel. More specifically, the collar is attached to the solution reservoir via an anchor and the collar's elongated body features a retention slot that catches the stem, thereby avoiding the projectile ejection of, for example, an eyewash assembly (or any other pressurized components or components attached to the pressurized components) in the event of decoupling without previous pressure reduction.

A pressurized container may be any container that has pressurized reservoir configured to store gas or liquid and a detachable valve section (e.g., pressurized components). For example, the pressurized container may be a gas storage container, a keg for a drink, a portable eyewash station, or other pressurized container. When detaching without first decreasing the pressure, pressurized components, such as a detachable valve section, may move at an increased speed due to the pressure and may cause injury to nearby personnel.

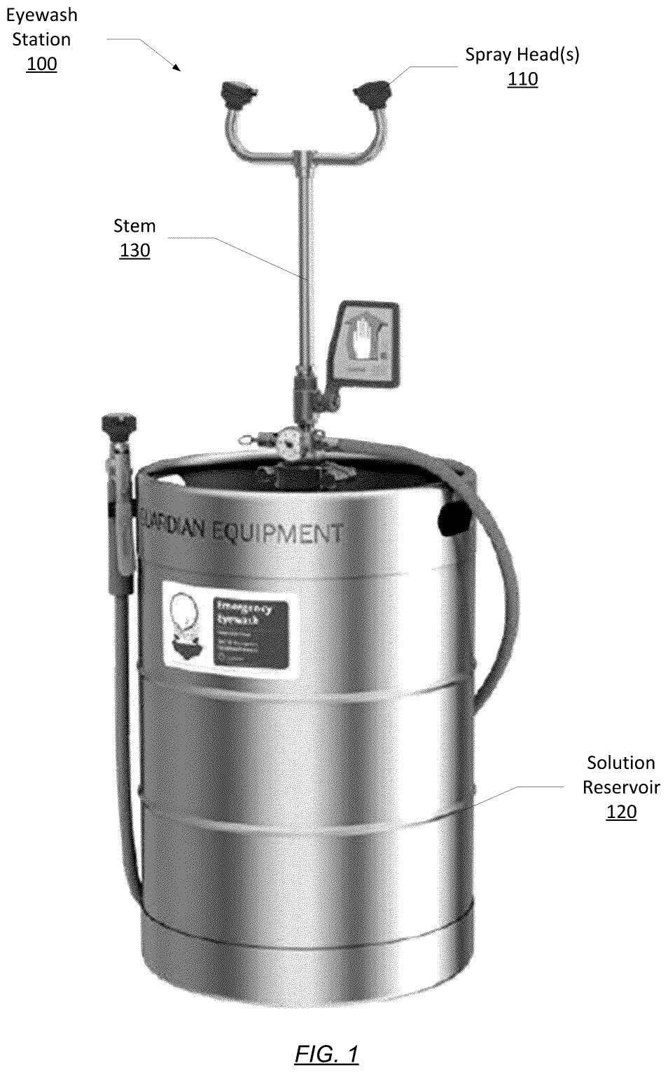

Turning to FIG. 1, a portable eyewash station is shown according to example embodiments.

The portable eyewash station is a safety equipment device designed to provide emergency flushing of the eyes in case of exposure to hazardous substances or contaminants. The specific components of a portable eyewash station can vary depending on the model and manufacturer, but typically include a number of common components.

The portable eyewash station (100) may include one or more spray head(s) (110) for flushing the eyes. Though not shown, the portable eyewash station (100) may include a bowl filled with sterile eyewash solution or a nozzle that delivers a gentle flow of eyewash fluid to the eyes.

The portable eyewash station (100) may include a solution reservoir (120). For self-contained eyewash stations, the solution reservoir (120) may include a container where the eyewash solution is stored and from which the eyewash solution is dispensed during use. Alternatively, the solution reservoir (120) may comprise a connection to a plumbed source water. In either case, the solution reservoir (120) provides a reservoir of sterile eyewash solution, usually water or saline, which is used to rinse the eyes and flush away contaminants.

The portable eyewash station (100) may include one or more additional components attached to a stem (130) connecting the spray head(s) (110) with the solution reservoir (120). These components can include an activation handle or foot pedal, a pressure control mechanism, and/or a fluid flow control valve, as well as pressure gauges, regulators, hoses, relief valves, and other accessories. Although FIG. 1 shows a portable eyewash station, analogous components are in other pressurized containers.

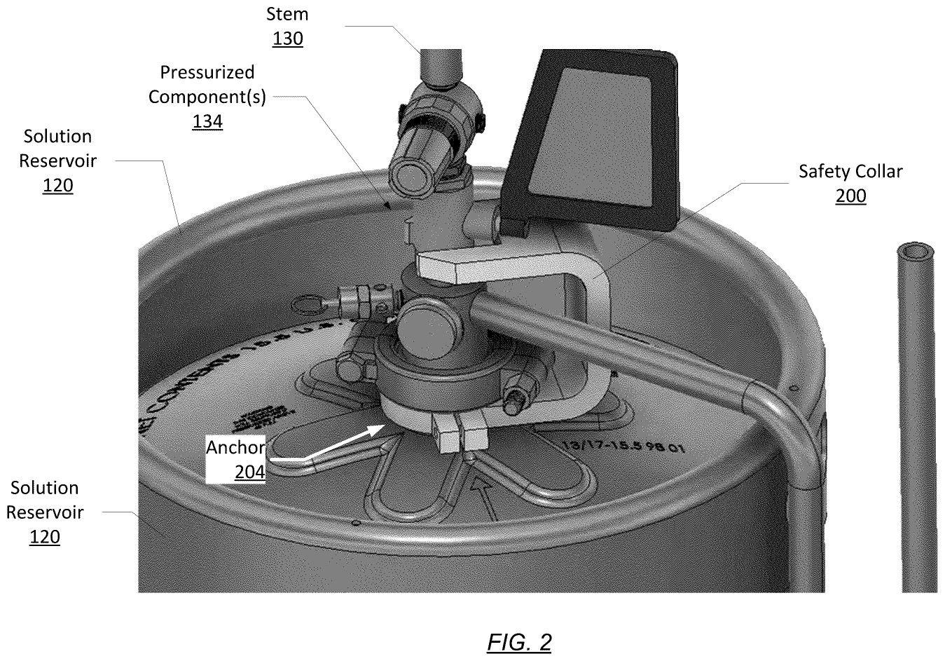

Turning to FIG. 2, a safety collar (200) is shown attached to a pressurized container according to example embodiments.

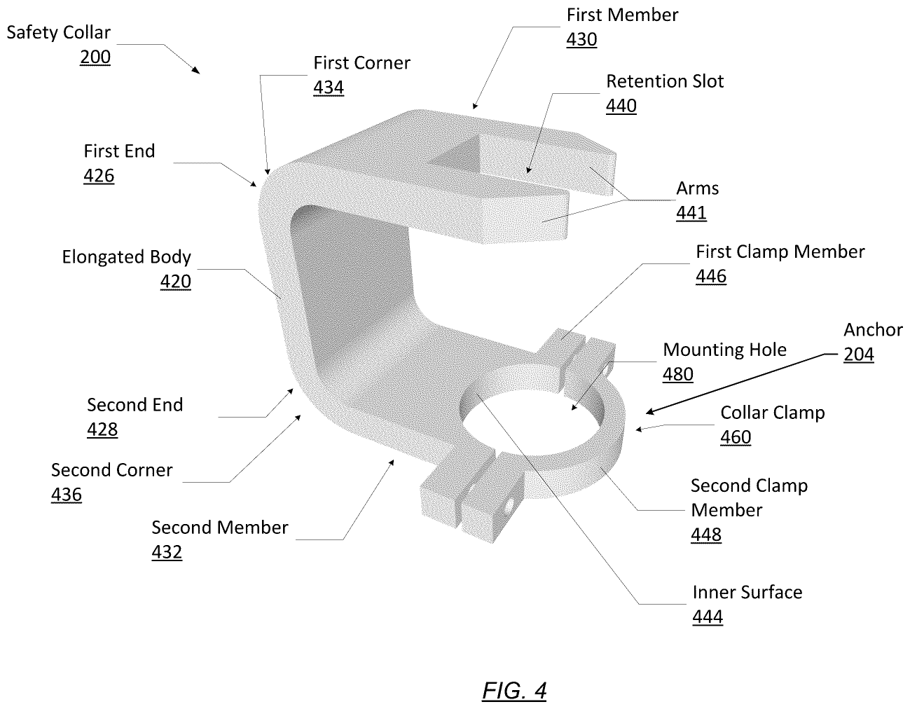

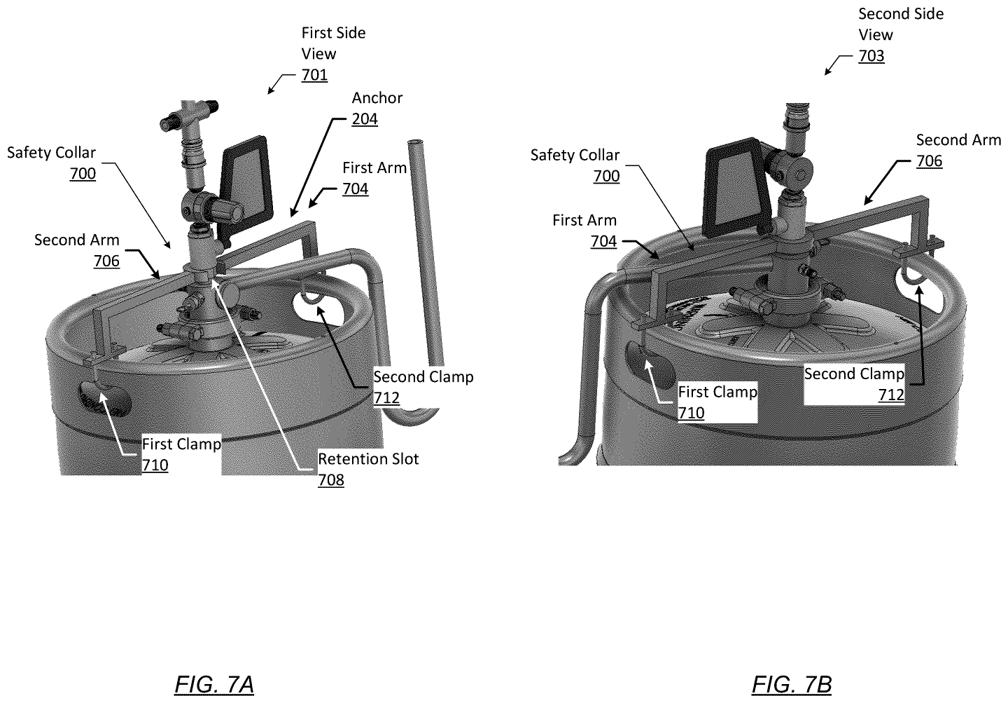

The safety collar (200) secures one or more pressurized components (134) to a solution reservoir (120) and more specifically, to a neck of a fluid source. It will be appreciated that the safety collar (200) can be attached or secured to any portion of the solution reservoir (120). The pressurized components (134) may be, for example, spray heads, handles, hoses, relief valves, a valve section, etc. An anchor (204) is designed to anchor or secure the safety collar (200) to the solution reservoir (120). In at least one embodiment, the anchor (204) is a collar clamp (460), illustrated in FIG. 4, designed to fit the neck of the solution reservoir (120) of the pressurized container firmly. To attach the safety collar (200) to the solution reservoir (120), the collar clamp (460) is installed around the neck and fastened securely using one or more fasteners. The fastener(s) may be a fastener that can apply sufficient torque to the collar clamp (460) onto the neck of the solution reservoir (120). In other words, the fastener(s) may be a fastener that can ensure that the collar clamp (460) is reliably and securely connected to the neck of the solution reservoir (120). The fasteners may be, for example, bolts, rivets, screws, cotter pins, or the like. This connection can be made without specialized tools in one or more embodiments. In another example, the anchor (204) is a first clamp (710) and a second clamp (712), illustrated in FIGS. 7A-7B, designed to attach to handles of a pressurized container.

In one or more embodiments, an elongated body (420) (shown in FIG. 4) of the safety collar (200) has a c-shape or u-shape to accommodate various components protruding from the stem (130). These components can include nozzles, pressure gauges, regulators, hoses, and/or relief valves. The shape of the elongated body (420) enables the safety collar (200) to fit diverse pressurized container designs.

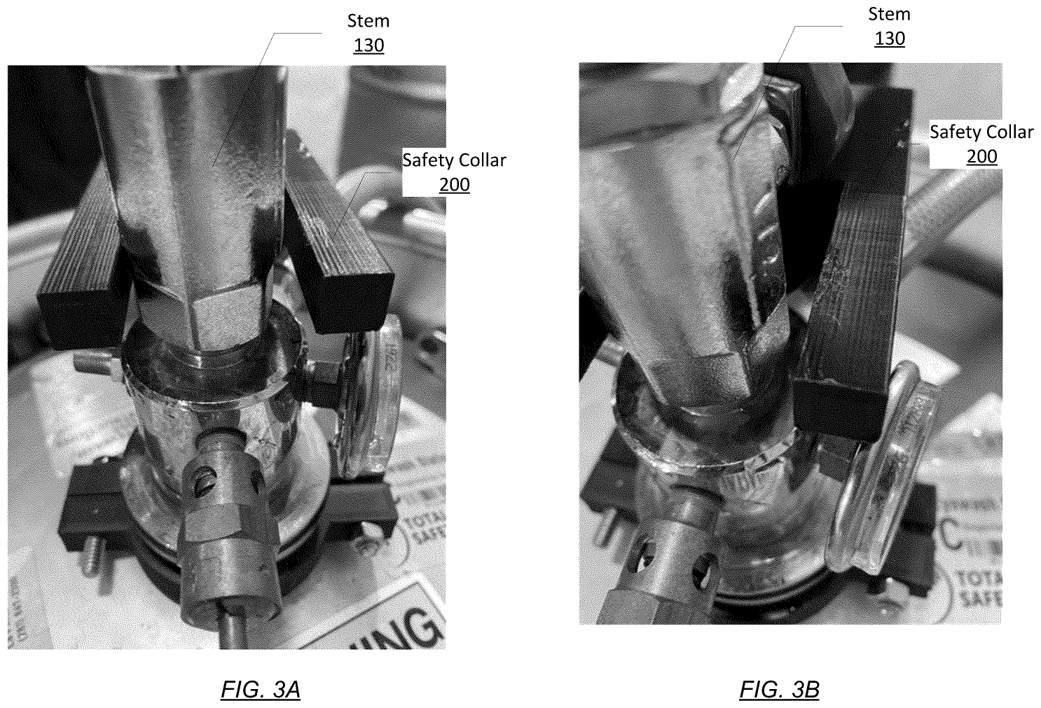

Turning to FIGS. 3A and 3B, additional views of the safety collar (200) are shown attached to a pressurized container according to illustrative embodiments. FIGS. 3A and 3B are further examples of the safety collar (200) shown attached to a solution reservoir (120) as illustrated in FIG. 2.

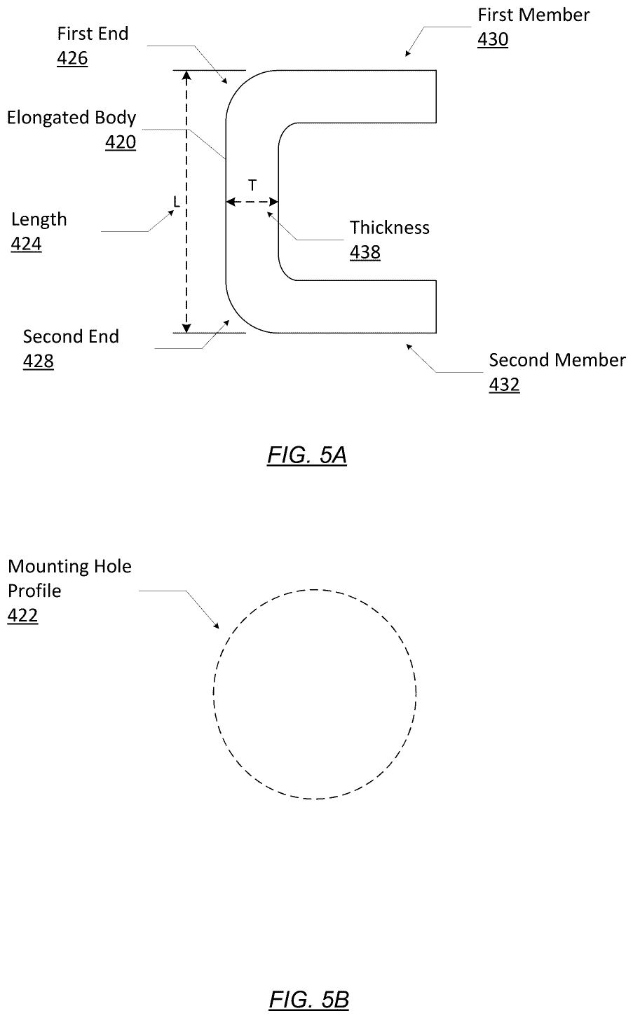

Turning to FIGS. 4, 5A, and 5B, a top, tilted view of the safety collar (200), a side, schematic drawing of the safety collar (200), and a schematic drawing of a mounting hole profile (422) are respectively shown.

The safety collar (200) is specifically designed to secure the pressurized components (134) of a pressurized container to the solution reservoir (120). In the illustrated embodiment, the safety collar (200) includes an elongated body (420) with a c-shaped or u-shaped configuration. The elongated body (420) extends a length L (424) (shown in FIG. 5A) from a first end (426) to a second end (428). A first member (430) extends from the elongated body (420) at the first end (426) and a second member (432) extends from the elongated body (420) at the second end (428). The first member (430) and the second member (432) each extend perpendicularly from the elongated body (420) in the illustrated embodiment. It will be appreciated that in other embodiments, the first member (430) and/or the second member (432) may extend at any angle from the elongated body (420).

The safety collar (200) can be plasma cut from, for example, a metal plate and bent on a press brake to form the c-shape or u-shape of the elongated body (420). The metal plate may be, for example, a steel plate. It will be appreciated that in other embodiments, the safety collar (200) can be formed from any solid material such as any metal or metal alloy.

The first member (430) and the elongated body (420) connect at a first corner (434). The second member (432) and the elongated body (420) connect at the second corner (436). As shown, the first corner (434) and the second corner (436) of the safety collar (200) are rounded to form radial corners. Such radial corners beneficially prevent stress from building at the first corner (434) and the second corner (436) when a force is applied to the safety clamp (200).

The safety collar (200) also has a thickness T (438) to reinforce the safety collar (200). The thickness T (438) may be, for example, at least ⅜″. In some embodiments the thickness T (438) is ½″. It will be appreciated that in other embodiments the thickness T (438) is less than or greater than ½″.

The safety collar (200) is engineered and sized to withstand a force applied to the safety collar (200) (and subsequently transferred to the solution reservoir (120)) in one or more embodiments. The length L (424) of the elongated body (420), the thickness T (438) of the safety collar (200), and the material of the safety collar (200) can be varied based on an expected or target force expected to be received by the safety collar (200). As previously stated, the radial corners formed at the first corner (434) and the second corner (436) also contribute to the design of the safety collar (200) to withstand a force applied to the safety collar (200) in the event of decoupling of the pressurized components (134) from the solution reservoir (120) without depressurization of the solution reservoir (120).

The c-shape or u-shape of the elongated body (420) may also enable the safety collar (200) to accommodate various components that protrude from the stem (130) of the pressurized container (100). These components could include pressure gauges, regulators, hoses, relief valves, and other accessories. More specifically, the length L (424) may be optimized to accommodate the various components while also enabling the pressurized components (134) to be sufficiently tilted during removal of the pressurized components (134).

The safety collar (200) features a retention slot (440) formed in the first member (430) and distal from the collar clamp (460). The retention slot (440) may be engineered and sized to engage the stem (130) of the pressurized container securely. In normal operation, the safety collar (200) remains affixed to the solution reservoir (120) via the collar clamp (460) and the retention slot (440) catches or retains the stem (130), to mitigate a risk of any unintended decoupling of the pressurized components (134). In the event that the safety collar (200) is removed or loosened without first decreasing pressure of the pressurized container, the retention slot (440) catches the stem (130), thereby preventing the sudden release of pressurized elements.

The retention slot (440) may be bounded on either side by one or more arms (441) to catch and/or to reduce wobbling of the stem (130), ensuring a tight fit. The ends of the arms (441) can be chamfered (as illustrated), rounded, or otherwise angled or blunted to reduce or eliminate hazards caused by sharp edges.

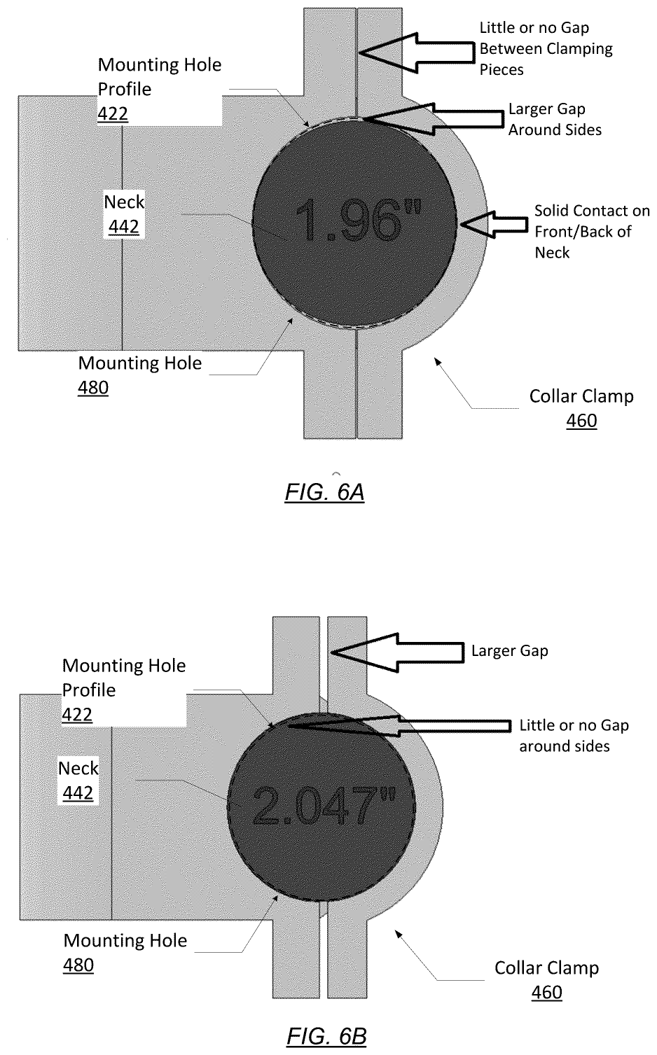

As shown in FIGS. 4 and 5B the collar clamp (460) may define a mounting hole (480) having a mounting hole profile (422). The mounting hole profile (422) shown in FIG. 5B is when the collar clamp (460) is in a closed position. In such position, the first clamp member (446) and the second clamp member (448) are connected and contact each other, as shown in FIG. 6A. In such instances, a diameter of a neck (442) around which the collar clamp (460) mounts to is substantially equal to or less than a smallest diameter of the mounting hole profile (422) such that the first clamp member (446) and the second clamp member (448) contact each other and leave little to no gap between the first clamp member (446) and the second clamp member (448). In instances where the diameter of the neck (442) is greater than the smallest diameter of the mounting hole profile (422), then the first clamp member (446) and the second clamp member (448) do not contact each other, as shown in FIG. 6B. In such instances, the mounting hole profile (422) is a different shape and size than the mounting hold profile (422) shown in FIG. 6A.

The mounting hole profile (422) is generally “eccentric” or ovate. A collar clamp (460) with an ovate mounting hole profile (422) may enable the safety collar (200) to securely attach to pressurized containers having different neck (442) sizes. Further, the collar clamp (460) includes a first clamp member (446) formed in the second member (432) of the safety collar (200) and a second clamp member (448) that can be releasably fixed to the first clamp member (446). The second clamp member (448) can be, for example, fastened to the first clamp member (446) using any fastener. In other examples, the second clamp member (448) may be releasably fixed or attached to the first clamp member (446) using, for example, adhesion, welding, or the like. In the illustrated embodiment, the first clamp member (446) and the second clamp member (448) are releasably fixed to each other on opposing sides of the collar clamp (460). In other embodiments, the first clamp member (446) and the second clamp member (448) may be fixed on one side and releasably fixed on an opposing side. In still other embodiments, the first clamp member (446) and the second clamp member (448) may be releasably fixed at any number of points along the collar clamp (460).

Due to the ovate-shaped size of the collar clamp (460) and the adjustability of the second clamp member (448) relative the first clamp member (446), the same collar clamp (460) can fit pressurized containers having different neck (442) diameters. For example, as shown in FIGS. 6A and 6B the same collar clamp (460) may fit neck (442) diameters of both 1.96 inches (FIG. 6A) and the 2.047 inches (FIG. 6B). It will be appreciated that the same collar clamp (460) can fit neck diameters less than or greater than 1.96 inches. In both examples, the collar clamp (460) can maintain sufficient contact with the neck (442). In some embodiments, at least 50% of a surface area of an inner surface (444) of the collar clamp (460) contacts the neck (442). In other embodiments, less than 50% of the surface area of the inner surface of the collar clamp (460) contacts the neck (442). The contact is at the front and back of the neck (442) as shown in FIG. 6A.

It will be appreciated that the safety collar (200) may be single use or may be used multiple times.

FIGS. 7A and 7B show another configuration of the safety collar (700) in one or more embodiments. Specifically, FIG. 7A shows a first side view (701) and FIG. 7B shows a second side view (703) of the pressurized container. In the example of FIGS. 7A and 7B, the safety collar (700) includes a retention slot (708) and an anchor (204) having at least two arms (i.e., a first arm (704), and a second arm (706)). It will also be appreciated that in some embodiments, the at least two arms include more than two arms. Each arm (704, 706) ends at a clamp (710, 712) configured to attach to the pressurized container. In the illustrated embodiment, the two arms (704, 706) extend radially outward from the retention slot (708) to clamp onto the sides of the pressurized container at the first clamp (710) and the second clamp (712). It will be appreciated that in other embodiments, the two arms (704, 706) (or any number of arms) may extend at any angle from the retention slot (708). In the illustrated embodiment, the clamps (710, 712) attach to handles of the pressurized container, but it will be appreciated that in other embodiments the clamps (710, 712) may attached to any portion of the pressurized container.

While FIGS. 1-7B show a configuration of components, other configurations may be used without departing from the scope. For example, various components may be combined to create a single component. As another example, the functionality performed by a single component may be performed by two or more components.

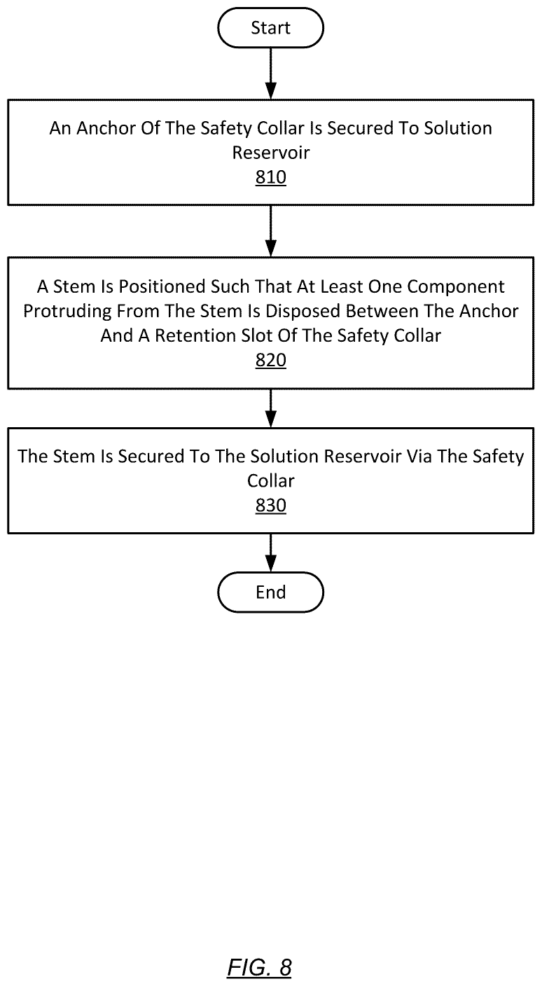

Turning to FIG. 8, a method for coupling a safety collar to a pressurized container is shown according to illustrative embodiments.

While the various steps in this flowchart are presented and described sequentially, at least some of the steps may be executed in different orders, may be combined, or omitted, and some of the steps may be performed in parallel. Furthermore, the steps may be performed actively or passively.

At step 810, an anchor of the safety collar is secured to a solution reservoir.

At step 820, a stem of the pressurized container is positioned such that at least one component protruding from the stem is disposed between the anchor and a retention slot of the safety collar. As described above, the safety collar in some embodiments may have an elongated body that is c-shaped, accommodating various components such as nozzles, pressure gauges, regulators, hoses, and relief valves. The shape of the elongated body enables the safety collar to address diverse pressurized container designs.

At step 830, the stem is secured to the solution reservoir via the safety collar.

The safety collar's retention slot aligns with the pressurized container's stem, catching and securing components if decoupling occurs. If decoupling happens under pressure, the retention slot engages components protruding from the stem of the pressurized container. The retention slot acts as a fail-safe, securing components even if the collar ring loosens. This prevents components from dislodging and launching from the pressurized vessel.

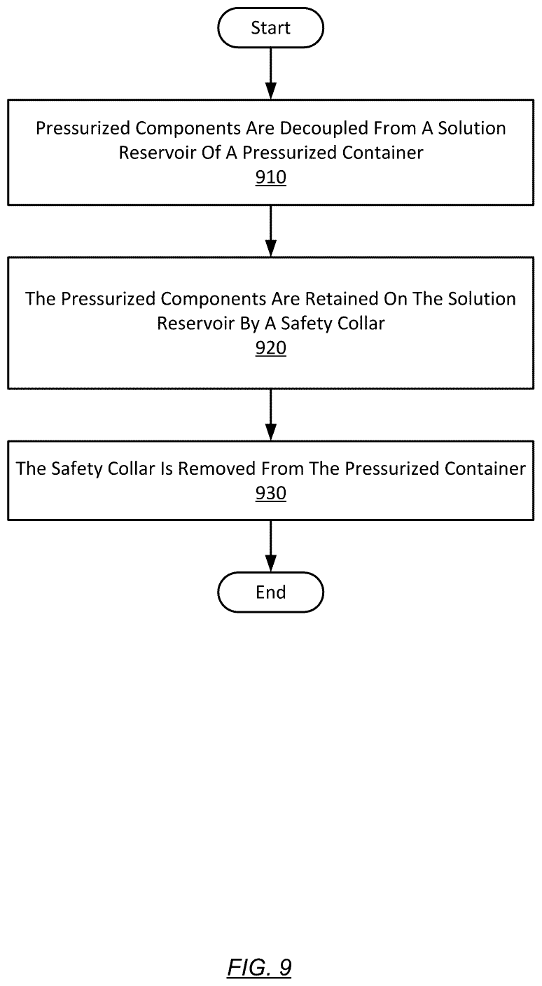

Turning to FIG. 9, a method for decoupling pressurized components from a pressurized container is shown according to illustrative embodiments.

While the various steps in this flowchart are presented and described sequentially, at least some of the steps may be executed in different orders, may be combined, or omitted, and some of the steps may be performed in parallel. Furthermore, the steps may be performed actively or passively.

At step 910, one or more pressurized components (e.g., spray heads, stems, handles, hoses, relief valves, a valve section, etc.) is decoupled from a solution reservoir of a pressurized container. In such decoupling, the one or more pressurized components may be tilted relative to a center axis of the solution reservoir. In other instances, the one or more pressurized components may be lifted parallel to the center axis.

At step 920, the one or more pressurized components are retained on the solution reservoir by a safety collar. In other words, when the one or more pressurized components are decoupled from the solution reservoir without first depressurizing the solution reservoir, a force is received by a safety collar installed on the pressurized container. More specifically, the safety collar is secured to the solution reservoir by an anchor (e.g., a collar clamp or one or more clamps) and a retention slot of the safety collar receives a portion of the pressurized component such as, for example, a stem. When the force is received by the safety collar due to decoupling of the pressurized components from the solution reservoir, the pressurized components are “caught” by the retention slot and anchored to the solution reservoir by the anchor. Thus, the safety collar prevents the pressurized components from dangerously ejecting from the solution reservoir, thereby increasing safety for users or personnel working on the pressurized container.

In some instances, a ring may be pulled by a user to release a pressure of the pressurized container prior to decoupling the pressurized components from the solution reservoir. In such instances, the decoupling can be performed when the safety collar is attached by pushing the pressurized components from the vertical orientation to an angle at an angular orientation, and then removing the pressurized components. If the valve is at the angle, it is less likely to hit personnel in the face and can be removed.

At step 930, the safety collar is removed from the pressurized container.

The disclosed safety collar (200) addresses the challenge of accidental decoupling of pressurized container components. By securely engaging with the stem (130) of the pressurized container at one portion of the safety collar (200) and being anchored to the pressurized container at another portion of the safety collar (200), the collar prevents the sudden release of pressurized components (134), safeguarding personnel from potential injuries. The collar's (200) elongated body (420) features a retention slot (440) designed to capture the stem (130) and an anchor (204) for securing the collar (200) to the pressurized container, ensuring that even in cases of unintended decoupling, projectile ejection of the eyewash assembly may be prevented.

The disclosed safety collar (200) may provide one or more of the following advantages:
Enhanced Safety: The safety collar (200) prevents the unintended decoupling of pressurized components (134), reducing the risk of injuries to personnel.
Versatile Design: The c-shaped elongated body (420) accommodates various protruding components, making the collar compatible with different pressurized container models.
Comprehensive Protection: The retention slot (440) effectively catches the stem (130) in the event of accidental decoupling, preventing the launch of the eyewash assembly.
Easy Installation: The safety collar (200) can be easily secured to a neck of the solution reservoir (120), adding a layer of safety without requiring complex modifications.

The safety collar (200) disclosed herein provides solutions that address unintended decoupling of pressurized components (134) in pressurized containers. By engaging a terminal retention with a stem such as the eyewash stem (130) described above, the safety collar (200) may provide protection against an unintended forcible discharge of pressurized elements from pressurized containers.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

The figures show diagrams of embodiments that are in accordance with the disclosure. The embodiments of the figures may be combined and may include or be included within the features and embodiments described in the other figures of the application. The features and elements of the figures are, individually and as a combination, improvements to the technology. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an inclusive “or” and, as such includes “and.” Further, items joined by an or may include any combination of the items with any number of each item unless expressly stated otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

In the above description, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description. Further, other embodiments not explicitly described above can be devised which do not depart from the scope of the one or more embodiments as disclosed herein. Accordingly, the scope of the one or more embodiments should be limited only by the attached claims.

What is claimed is:

1. A safety collar comprising:
an elongated body extending from a first end to a second end;
a first member extending from the first end, the first member extending perpendicularly to the elongated body;
a second member extending from the second end, the second member extending perpendicularly to the elongated body;
a retention slot formed in the first member, the retention slot operable to receive a first portion of a pressurized container; and
a collar clamp formed in the second member, the clamp operable to receive a second portion of the pressurized container,
wherein the retention slot anchors the first portion to the second portion when the first portion is decoupled from the second portion while pressurized.

2. The safety collar of claim 1, wherein the first portion of the pressurized container comprises at least one pressurized component and the second portion of the pressurized container comprises a solution reservoir.

3. The safety collar of claim 1, further comprising:
a first corner formed at the first member and the elongated body, and a second corner formed at the second member and the elongated body.

4. The safety collar of claim 3, wherein the first corner and the second corner are each rounded, radial corners.

5. The safety collar of claim 1, wherein the safety collar has a thickness of at least ⅜″.

6. The safety collar of claim 1, wherein the collar clamp comprises a first clamp member formed in the second member and a second clamp member that is releasably secured to the first clamp member.

7. The safety collar of claim 1, wherein the collar clamp comprises a mounting hole defining a mounting hole profile.

8. The safety collar of claim 7, wherein the mounting hole profile has an ovate shape.

9. The safety collar of claim 1, wherein the retention slot is defined by a pair of arms.

10. The safety collar of claim 9, wherein each arm of the pair of arms comprises at least one of a rounded or chamfered end.

11. A system comprising:
a pressurized container having a solution reservoir and one or more pressurized components releasably attached to and extending from the solution reservoir; and
a safety collar having a retention slot operable to receive at least a portion of the one or more pressurized components and an anchor operable to be anchored to the solution reservoir,
wherein the retention slot anchors the one or more pressurized components to the solution reservoir when the pressurized container is decoupled from the solution reservoir while pressurized.

12. The system of claim 11, wherein the safety collar has a thickness of at least ⅜″.

13. The system of claim 11, wherein the anchor comprises:
a first arm extending from the retention slot; and
a second arm extending from the retention slot in an opposite direction of the first arm,
wherein the first arm extends to a first clamp operable to be secured to the solution reservoir at a first location and the second arm extends to a second clamp operable to be secured to the solution reservoir at a second location.

14. The system of claim 11, wherein safety collar comprises:
an elongated body extending from a first end to a second end;
a first member extending from the first end, the first member extending perpendicularly to the elongated body; and
a second member extending from the second end, the second member extending perpendicularly to the elongated body,
wherein the retention slot is formed in the first member and the anchor is formed in the second member.

15. The system of claim 14, wherein the anchor is a collar clamp, and the collar clamp comprises a first clamp member formed in the second member and a second clamp member that is releasably secured to the first clamp member.

16. The system of claim 15, wherein the collar clamp comprises a mounting hole defining a mounting hole profile.

17. The system of claim 16, wherein the mounting hole profile has an ovate shape.

18. A method of decoupling one or more pressurized components from a solution reservoir of a pressurized container, the method comprising:
decoupling the one or more pressurized components from the solution reservoir, the solution reservoir being pressurized;
retaining the one or more pressurized components on the solution reservoir when the one or more pressurized components are decoupled from the solution reservoir by a safety collar, the safety collar having an anchor secured to the solution reservoir and a retention slot retaining the one or more pressurized components; and
removing the safety collar from the pressurized container.

19. The method of claim 18, wherein safety collar comprises:
an elongated body extending from a first end to a second end;
a first member extending from the first end, the first member extending perpendicularly to the elongated body; and
a second member extending from the second end, the second member extending perpendicularly to the elongated body,
wherein the retention slot is formed in the first member and the anchor is formed in the second member.

20. The method of claim 18, wherein the anchor comprises:
a first arm extending from the retention slot; and
a second arm extending from the retention slot in an opposite direction of the first arm,
wherein the first arm extends to a first clamp operable to be secured to the solution reservoir at a first location and the second arm extends to a second clamp operable to be secured to the solution reservoir at a second location.
